(19) United States
(12) Patent Application Publication
(10) Pub. No.: US 2026/0300821 A1
(43) Pub. Date: Oct. 1, 2026

(54) MONITORED VOLTAGE AND CURRENT OVERSIGHT FOR TRANSDUCER MODEL MODIFICATION AND ADAPTATION

(71) Applicant: Cirrus Logic International Semiconductor Ltd., Edinburgh (GB)

(72) Inventors: Ning LI, Cedar Park, TX (US); Michael KUREK, Austin, TX (US); Jason KULPE, Austin, TX (US)

(73) Assignee: Cirrus Logic International Semiconductor Ltd., Edinburgh (GB)

(21) Appl. No.: 19/439,632

(22) Filed: Jan. 5, 2026

Related U.S. Application Data
(60) Provisional application No. 63/777,964, filed on Mar. 26, 2025.

(30) Foreign Application Priority Data
Apr. 15, 2025 (GB) 2505616.9

(51) Int. Cl. G06N 20/00

(52) U.S. Cl. CPC G06N 20/00

(57) ABSTRACT

A system may include an excursion detection subsystem configured to estimate excursion of an internal mass of an electromechanical transducer. The excursion detection subsystem may include an excursion model configured to apply a transfer function to a driving signal for driving the electromechanical transducer to generate an estimated excursion of the internal mass in response to the driving signal, a training module configured to adapt parameters of the excursion model based on one or more factors, an oversight and control module configured to control adaptation by the training module based on at least one sensed signal associated with the electromechanical transducer, and an excursion limiter configured to determine if the estimated excursion is an over-excursion of the internal mass and mitigate the over-excursion if the estimated excursion is an over-excursion of the internal mass.

### RELATED APPLICATIONS

The present disclosure claims priority to United Kingdom Patent Application No. 2505616.9, filed Apr. 15, 2025, and United States Provisional Patent Application No. 63/777964, filed Mar. 26, 2025, each of which is incorporated by reference herein in its entirety.

### FIELD OF DISCLOSURE

The present disclosure relates in general to methods, apparatuses, or implementations for electromagnetic transducers, including haptic devices and loudspeakers. In particular, embodiments set forth herein may disclose systems and methods for detection and prevention of over-excursion, excessive heat dissipation, or other concerns in an electromagnetic transducer.

### BACKGROUND

Portable devices such as mobile phones often employ electromagnetic transducers, such as loudspeakers and vibro-haptic transducers. Loudspeakers have long been used in portable devices for generating audio playback.

Vibro-haptic transducers, for example linear resonant actuators (LRAs), are widely used in portable devices to generate vibrational feedback to a user. Vibro-haptic feedback in various forms creates different feelings of touch to a user's skin and may play increasing roles in human-machine interactions for modern devices.

An LRA may be modelled as a mass-spring-damper electro-mechanical vibration system. When driven with appropriately designed or controlled driving signals, an LRA may generate certain desired forms of vibrations. For example, a sharp and clear-cut vibration pattern on a user's finger may be used to create a sensation that mimics a mechanical button click. This clear-cut vibration may then be used as a virtual switch to replace mechanical buttons.

When driving an electromagnetic transducer with an electrical signal, an internal mass of the transducer may collide with its external housing, which may have undesirable effects, including permanent damage to the transducer, changes to transducer characteristics, undesirable audio artifacts (e.g., a loud “clack” as the internal mass strikes the external housing), and/or distorted haptics or audio effects. Typically, if only “known” content of the form of pre-stored waveforms is played back to a haptic transducer, such collisions may be avoided. However, if playback conditions change or if unknown content is played back (e.g., streaming with audio-to-haptic playback), such collisions may occur. While restricting a playback level for unknown content may mitigate or eliminate such collision events, such restrictions may weaken haptic effects.

Manufacturers of electromagnetic transducers often specify a maximum signal voltage (e.g., a maximum number of volts, root-mean-square, at a particular frequency) to minimize or eliminate damage. An excursion limit in terms of displacement or distance may be inferred from such voltage limit. However, with unknown playback content, it may be difficult to adhere to a manufacturer's inferred excursion limit for under-damped devices, such as haptic transducers or loudspeakers.

For a given steady-state input voltage signal (or a transient signal with high enough amplitude), the response of an LRA may become increasingly non-linear as the amplitude of the voltage increases beyond a certain limit—usually specified as the working voltage level by the LRA manufacturer. This non-linearity typically results from amplitude-dependent changes to the spring constant associated with the springs that suspend the inner mass of the LRA. Such amplitude dependency is typically most prominent at higher voltage levels. Depending on the construction of the LRA, large enough input signals driven at or near the resonance frequency may displace the inner-mass of the LRA to such an extent that it contacts an enclosure of the LRA or its mechanical end-stops. Such behavior is typically referred to as over-excursion. Such occurrence can negatively impact user experience and, in some cases, physically damage the LRA. Accordingly, systems and methods for detection of and protection from such over-excursion may be desired.

Methods and systems for limiting excursion for speakers exist, but often do not work well for under-damped devices such as LRAs. In addition, many methods and systems for limiting excursion often require feedback, such as using a microphone to sense an audio output signal of a loudspeaker or the use of other sensors, which may add undesirable cost and complexity to a system.

Accordingly, other approaches for preventing over-excursion for electromagnetic transducers may be desired.

### SUMMARY

In accordance with the teachings of the present disclosure, the disadvantages and problems associated with existing approaches for generating a haptic waveform for an electromagnetic transducer may be reduced or eliminated.

In accordance with embodiments of the present disclosure, a system may include an excursion detection subsystem configured to estimate excursion of an internal mass of an electromechanical transducer. The excursion detection subsystem may include an excursion model configured to apply a transfer function to a driving signal for driving the electromechanical transducer to generate an estimated excursion of the internal mass in response to the driving signal, a training module configured to adapt parameters of the excursion model based on one or more factors, an oversight and control module configured to control adaptation by the training module based on at least one sensed signal associated with the electromechanical transducer, and an excursion limiter configured to determine if the estimated excursion is an over-excursion of the internal mass and mitigate the over-excursion if the estimated excursion is an over-excursion of the internal mass.

In accordance with these and other embodiments of the present disclosure, a method may include, in an excursion detection subsystem configured to estimate excursion of an internal mass of an electromechanical transducer, applying, with an excursion model, a transfer function to a driving signal for driving the electromechanical transducer to generate an estimated excursion of the internal mass in response to the driving signal. The method may also include adapting, with a training model, parameters of the excursion model based on one or more factors. The method may also include controlling, with an oversight and control module, adaptation by the training module based on at least one sensed signal associated with the electromechanical transducer. The method may further include determining if the estimated excursion is an over-excursion of the internal mass and mitigating the over-excursion if the estimated excursion is an over-excursion of the internal mass.

Technical advantages of the present disclosure may be readily apparent to one having ordinary skill in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of an example host device, in accordance with embodiments of the present disclosure;

FIG. 2 illustrates a block diagram of selected components of an example excursion detector, in accordance with embodiments of the present disclosure;

FIG. 3 illustrates a functional block diagram of an example oversight/control module, in accordance with embodiments of the present disclosure; and

FIG. 4 illustrates an example state diagram for operation of an example adaptation status detection block of an oversight/control module, in accordance with embodiments of the present disclosure.

### DETAILED DESCRIPTION

The description below sets forth example embodiments according to this disclosure. Further example embodiments and implementations will be apparent to those having ordinary skill in the art. Further, those having ordinary skill in the art will recognize that various equivalent techniques may be applied in lieu of, or in conjunction with, the embodiment discussed below, and all such equivalents should be deemed as being encompassed by the present disclosure.

Various electronic devices or smart devices may have transducers, speakers, and acoustic output transducers, for example any transducer for converting a suitable electrical driving signal into an acoustic output such as a sonic pressure wave or mechanical vibration. For example, many electronic devices may include one or more speakers or loudspeakers for sound generation, for example, for playback of audio content, voice communications and/or for providing audible notifications.

Such speakers or loudspeakers may comprise an electromagnetic actuator, for example a voice coil motor, which is mechanically coupled to a flexible diaphragm, for example a conventional loudspeaker cone, or which is mechanically coupled to a surface of a device, for example the glass screen of a mobile device. Some electronic devices may also include acoustic output transducers capable of generating ultrasonic waves, for example for use in proximity detection-type applications and/or machine-to-machine communication.

Many electronic devices may additionally or alternatively include more specialized output transducers, for example, haptic transducers, tailored for generating vibrations for haptic control feedback or notifications to a user. Additionally or alternatively, an electronic device may have a connector, e.g., a socket, for making a removable mating connection with a corresponding connector of an accessory apparatus, and may be arranged to provide a driving signal to the connector so as to drive a transducer, of one or more of the types mentioned above, of the accessory apparatus when connected. Such an electronic device will thus comprise driving circuitry for driving the transducer of the host device or connected accessory with a suitable driving signal. For acoustic or haptic transducers, the driving signal may generally be an analog time varying voltage signal, for example, a time varying waveform.

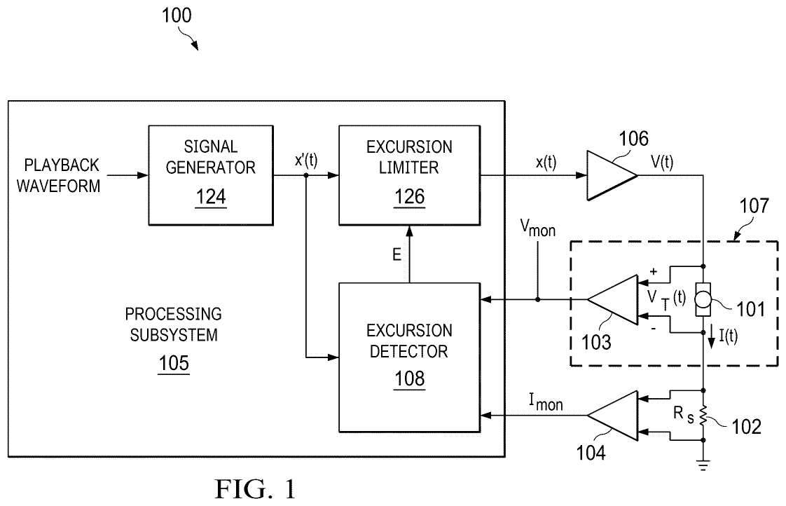

FIG. 1 illustrates a block diagram of selected components of an example host device 100, in accordance with embodiments of the present disclosure. Host device 100 may include, without limitation, a mobile device, home application, vehicle, and/or any other system, device, or apparatus that includes a human-machine interface. As shown in FIG. 1, host device 100 may comprise, among other things, a processing subsystem 105, an amplifier 106, and an electromagnetic load 101.

Electromagnetic load 101 may include any suitable load with a complex impedance, including without limitation a haptic transducer, a loudspeaker, a microspeaker, a piezoelectric transducer, or other suitable transducer.

In operation, a signal generator 124 of processing subsystem 105 of host device 100 may generate a raw transducer driving signal x′t) (which, in some embodiments, may be a waveform signal, such as a haptic waveform signal or audio signal). Raw transducer driving signal x′(t) may be generated based on a desired playback waveform received by signal generator 124.

Raw transducer driving signal x′(t) may be received by an excursion limiter 126 of processing subsystem 105 which, as described in greater detail below, may optimize raw transducer driving signal x′(t) based on an estimated excursion E generated by an excursion detector 108 of processing subsystem 105 to generate processed transducer driving signal x(t). For example, if excursion limiter 126 determines estimated excursion E to be over an excursion limit, excursion limiter 126 may apply an attenuation to raw transducer driving signal x′t) to prevent an actual over-excursion from occurring.

Processed transducer driving signal x(t) may in turn be amplified by amplifier 106 to generate a driving signal V(t) for driving electromagnetic load 101. Responsive to driving signal V(t), a sensed terminal voltage V_{T}(t) of electromagnetic load 101 may be sensed by a terminal voltage sensing block 107, for example a volt-meter, and converted to a digital representation (e.g., monitored voltage V_{MON}) by a first analog-to-digital converter (ADC) 103. Similarly, sensed current I(t) may be converted to a digital representation (e.g., monitored current I_{MON}) by a second ADC 104. Current I(t) may be sensed across a shunt resistor 102 having resistance Rₛ coupled to a terminal of electromagnetic load 101.

As shown in FIG. 1, processing subsystem 105 may include an excursion detector 108, configured to, based on the playback waveform (e.g., a level or magnitude of the playback waveform), and estimated temperature of electromagnetic load 101 (e.g., which may be based on monitored voltage V_{MON} and/or monitored current I_{MON}), and/or other factors, generate excursion estimate E. In addition, as described in greater detail below, excursion detector 108 may maintain an excursion model of electromagnetic load 101 to model excursion of electromagnetic load 101 as a function of the playback waveform. Further, as also described in greater detail below, excursion detector 108 may, using machine learning, linear mapping, or other technique, adapt the excursion model based on the initial excursion model as a function of input level/magnitude of the playback waveform, temperature of electromagnetic load 101, and/or other factors, in order to optimize calculation of excursion estimate E based on signal conditions, environmental conditions, and/or other conditions.

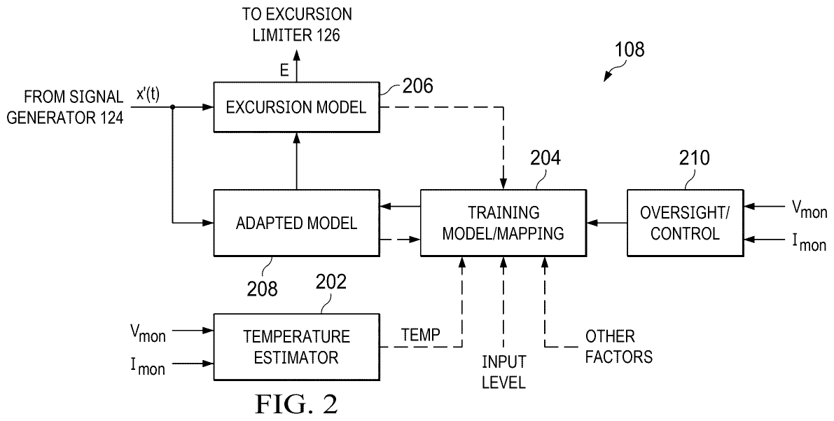

FIG. 2 illustrates a block diagram of selected components of an example excursion detector 108, in accordance with embodiments of the present disclosure. As shown in FIG. 2, excursion detector 108 may include a temperature estimator 202, a training model/mapping module 204, an excursion model 206, an adapted model 208, and an oversight/control module 210.

Temperature estimator 202 may comprise any system, device, or apparatus configured to, based on monitored voltage V_{MON} and monitored current I_{MON}, estimate a temperature TEMP of electromagnetic transducer 101. For example, in some embodiments, temperature estimator 202 may be configured to, based on monitored voltage V_{MON} and monitored current I_{MON}, estimate a resistance of a coil of electromagnetic transducer 101, and further from such estimated resistance, estimate temperature TEMP and communicate such estimate to training model/mapping module 204.

Training model/mapping module 204 may comprise any system, device, or apparatus configured to implement a machine learning algorithm and/or a linear mapping in order to generate parameters for adapting adapted model 208 based on temperature TEMP, an input level (e.g., magnitude) or the playback waveform, and/or other factors. Such training may be performed online or offline, although training online may allow training model/mapping module 204 to adapt to new data. For example, data for different LRAs, temperatures, and signal levels may be collected for training.

Excursion model 206 may comprise any system, device, or apparatus configured to apply an electrical drive-to-excursion transfer function such that when the electrical drive-to-excursion transfer function is applied to a raw driving signal x′(t), the result is an estimated excursion E of electromagnetic load 101 if raw driving signal x′(t) were to be hypothetically applied to electromagnetic load 101 (or to amplifier 106 which in turn drives electromagnetic load 101) without any excursion limiting by excursion limiter 126. For example, excursion model 206 may be based on characteristics derived from testing and/or characterization of electromagnetic load 101 in response to driving voltages at various frequencies and/or amplitudes of raw driving signal x′(t), various temperatures, and/or at other various conditions. Further, in some embodiments, such testing and/or characterization may be made on a per-host device or per-electromagnetic load basis, meaning each host device 100 may have its own unique excursion model 206.

Adapted model 208 may comprise any system, device, or apparatus configured to represent an initial model state of excursion model 206, as adapted over time based on the parameters for adapting adapted model 208 generated by training model/mapping module 204. As adapted model 208 is adapted over time, its model parameters may from time to time be updated from adapted model 208.

Oversight/control module 210 may comprise any system, device, or apparatus configured to, based on monitored voltage V_{MON} and monitored current I_{MON}, provide oversight and control over adaptation by training model/mapping module 204. For example, because monitored voltage V_{MON} and monitored current I_{MON} may be indicative of temperature, changes in temperature, and excursion, oversight/control module 210 may be able to control adaptation based on whether monitored voltage V_{MON} and monitored current I_{MON} are within respective ranges or have specific conditions.

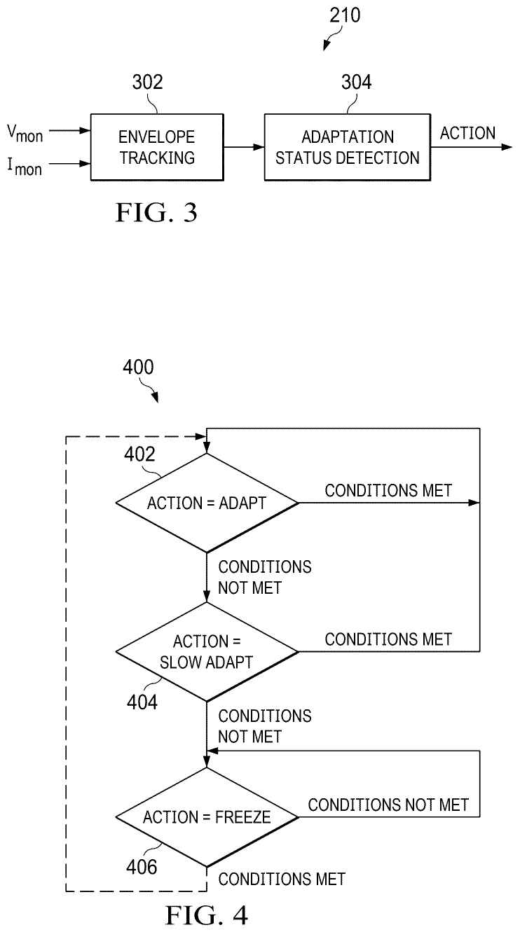

FIG. 3 illustrates a functional block diagram of oversight/control module 210, in accordance with embodiments of the present disclosure. As shown in FIG. 3, an envelope tracking block 302 may track signal envelopes for one or both of monitored voltage V_{MON} and monitored current I_{MON}. Based on such signal envelopes, an adaptation status detection block 304 may determine whether monitored voltage V_{MON} and monitored current I_{MON} are within respective ranges or have specific conditions, and generate an action based on such determination, wherein such action may control adaptation by training model/mapping module 204.

For example, FIG. 4 illustrates an example state diagram 400 for operation of adaptation status detection block 304, in accordance with embodiments of the present disclosure. As shown in FIG. 4, in various states of state diagram 400, adaptation status detection block 304 may determine whether one or more predetermined conditions for monitored voltage V_{MON} and/or monitored current I_{MON} are met, and based thereon, determine whether to change states within state diagram 400 or remain at the same state within state diagram 400.

At a state 402 of state diagram 400, adaptation status detection block 304 may generate an action indicating that training model/mapping module 204 shall perform normal adaptation, and thus may cause training model/mapping module 204 to perform normal adaptation. Once in state 402, as long as the one or more predetermined conditions for monitored voltage V_{MON} and/or monitored current I_{MON} are met, state diagram 400 may remain at state 402. However, if, while in state 402, the one or more predetermined conditions for monitored voltage V_{MON} and/or monitored current I_{MON} are no longer met, state diagram 400 may proceed to a state 404.

At state 404 of state diagram 400, adaptation status detection block 304 may generate an action indicating that training model/mapping module 204 shall perform slow adaptation, and thus may cause training model/mapping module 204 to perform slow adaptation. While in state 404, if the one or more predetermined conditions for monitored voltage V_{MON} and/or monitored current I_{MON} are met, state diagram 400 may proceed to state 402. On the other hand, while in state 404, if the one or more predetermined conditions for monitored voltage V_{MON} and/or monitored current I_{MON} are not met, state diagram 400 may proceed to a state 406.

At state 406 of state diagram 400, adaptation status detection block 304 may generate an action indicating that training model/mapping module 204 shall freeze adaptation, and thus may cause training model/mapping module 204 to freeze adaptation. While in state 406, if the one or more predetermined conditions for monitored voltage V_{MON} and/or monitored current I_{MON} are met, state diagram 400 may proceed to state 404 (or in some embodiments proceed to state 402). On the other hand, while in state 406, if the one or more predetermined conditions for monitored voltage V_{MON} and/or monitored current I_{MON} are not met, state diagram 400 may remain at state 406.

Thus, adaptation status detection block 304 may generate an action to cause adaptation to slow if the one or more predetermined conditions for monitored voltage V_{MON} and/or monitored current I_{MON} are not met, and generate an action to cause adaptation to freeze if the one or more predetermined conditions for monitored voltage V_{MON} and/or monitored current I_{MON} are not met for multiple sampling cycles, while generating an action to cause normal adaptation is the one or more predetermined conditions for when monitored voltage V_{MON} and/or monitored current I_{MON} are met.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. A system comprising:
an excursion detection subsystem configured to estimate excursion of an internal mass of an electromechanical transducer, the excursion detection subsystem comprising:
an excursion model configured to apply a transfer function to a driving signal for driving the electromechanical transducer to generate an estimated excursion of the internal mass in response to the driving signal;
a training module configured to adapt parameters of the excursion model based on one or more factors; and
an oversight and control module configured to control adaptation by the training module based on at least one sensed signal associated with the electromechanical transducer; and
an excursion limiter configured to:
determine if the estimated excursion is an over-excursion of the internal mass; and
mitigate the over-excursion if the estimated excursion is an over-excursion of the internal mass.

2. The system of claim 1, wherein the one or more factors comprise an estimated temperature associated with the electromechanical transducer.

3. The system of claim 2, wherein the estimated temperature is based on the at least one sensed signal.

4. The system of claim 3, wherein the at least one sensed signal comprises one or more of a voltage associated with the electromechanical transducer and a current associated with the electromechanical transducer.

5. The system of claim 1, wherein the one or more factors comprise a magnitude of the driving signal.

6. The system of claim 1, wherein the at least one sensed signal comprises one or more of a voltage associated with the electromechanical transducer and a current associated with the electromechanical transducer.

7. The system of claim 1, wherein the oversight and control module is configured to control adaptation based on whether the at least one sensed signal satisfies one or more conditions.

8. The system of claim 7, wherein the oversight and control module is configured to enable normal adaptation by the training module if the at least one sensed signal satisfies the one or more conditions.

9. The system of claim 7, wherein the oversight and control module is configured to slow adaptation by the training module if the at least one sensed signal fails to satisfy the one or more conditions.

10. The system of claim 7, wherein the oversight and control module is configured to freeze adaptation by the training module if the at least one sensed signal fails to satisfy the one or more conditions.

11. The system of claim 7, wherein the oversight and control module is configured to freeze adaptation by the training module if the at least one sensed signal fails to satisfy the one or more conditions for a number of successive cycles.

12. The system of claim 1, wherein the electromagnetic transducer is one of a haptic transducer, a voice coil, and a loudspeaker.

13. A method comprising, in an excursion detection subsystem configured to estimate excursion of an internal mass of an electromechanical transducer:
applying, with an excursion model, a transfer function to a driving signal for driving the electromechanical transducer to generate an estimated excursion of the internal mass in response to the driving signal;
adapting, with a training model, parameters of the excursion model based on one or more factors; and
controlling, with an oversight and control module, adaptation by the training module based on at least one sensed signal associated with the electromechanical transducer;
determining if the estimated excursion is an over-excursion of the internal mass; and
mitigating the over-excursion if the estimated excursion is an over-excursion of the internal mass.

14. The method of claim 13, wherein the one or more factors comprise an estimated temperature associated with the electromechanical transducer.

15. The method of claim 14, wherein the estimated temperature is based on the at least one sensed signal.

16. The method of claim 15, wherein the at least one sensed signal comprises one or more of a voltage associated with the electromechanical transducer and a current associated with the electromechanical transducer.

17. The method of claim 13, wherein the one or more factors comprise a magnitude of the driving signal.

18. The method of claim 13, wherein the at least one sensed signal comprises one or more of a voltage associated with the electromechanical transducer and a current associated with the electromechanical transducer.

19. The method of claim 13, further comprising controlling adaptation, with the oversight and control module, based on whether the at least one sensed signal satisfies one or more conditions.

20. The method of claim 19, further comprising enabling, with the oversight and control module, normal adaptation by the training module if the at least one sensed signal satisfies the one or more conditions.

21. The method of claim 19, further comprising slowing, with the oversight and control module, adaptation by the training module if the at least one sensed signal fails to satisfy the one or more conditions.

22. The method of claim 19, further comprising freezing, with the oversight and control module, adaptation by the training module if the at least one sensed signal fails to satisfy the one or more conditions.

23. The method of claim 19, further comprising freezing, with the oversight and control module, adaptation by the training module if the at least one sensed signal fails to satisfy the one or more conditions for a number of successive cycles.

24. The method of claim 13, wherein the electromagnetic transducer is one of a haptic transducer, a voice coil, and a loudspeaker.
